(19) United States
(12) Patent Application Publication
(10) Pub. No.: US 2014/0352468 A1
(43) Pub. Date: Dec. 4, 2014

(54) REDUCER OF ELECTRIC POWER STEERING APPARATUS

(71) Applicant: MANDO CORPORATION, Pyeongtaek-si (KR)

(72) Inventor: Tae Sik KIM, Yongin-si (KR)

(73) Assignee: MANDO CORPORATION, Pyeongtaek-si (KR)

(21) Appl. No.: 14/285,574

(22) Filed: May 22, 2014

(30) Foreign Application Priority Data
May 29, 2013 (KR) 10-2013-0061022

(51) Int. Cl. B62D 3/04; F16H 57/12

(52) U.S. Cl. CPC B62D 3/04; F16H 57/12
USPC 74/409

(57) ABSTRACT

Discloses is a reducer of an electric power steering apparatus. The reducer of the electric power steering apparatus can reduce the rattling noise caused by an increase of backlash due to friction and abrasion of a worm and a worm wheel or by an impact transferred through a wheel and a steering shaft from the road and allowing a pivotal movement of a worm shaft, while decreasing a rotation resistance and blockage of a worm shaft and a worm shaft bearing to increase steering feel of a driver.

### CROSS-REFERENCE TO RELATED APPLICATION

This application claims the priority under 35 U.S.C. §119(a) to Korean Application Serial No. 10-2013-0061022, which was filed in the Korean Intellectual Property Office on May 29, 2013, the entire content of which is hereby incorporated by reference.

### BACKGROUND OF THE INVENTION

1. Field of the Invention

The present invention relates to a reducer of an electric power steering apparatus, and more particularly to a reducer of an electric power steering apparatus, which is capable of reducing a rattling noise caused by an increase of a backlash due to a friction and abrasion of a worm and a worm wheel or by an impact transferred through a wheel and a steering shaft from the road and allowing a pivotal movement of a worm shaft, while decreasing a rotation resistance and blockage of a worm shaft and a worm shaft bearing to increase steering feel of a driver.

2. Description of the Related Art

FIG. 1 is a view illustrating a conventional electric power steering apparatus. As shown in FIG. 1, the electric power steering apparatus 100 includes a steering column 130 having a steering wheel 102 disposed over a driver's seat and a steering shaft 106 connected to the steering wheel 102 to connect the steering shaft to a vehicle body, a rack and pinion mechanism 110 which includes a rack gear and a pinion gear for converting a rotation force input from the steering shaft 106 into a straight movement, and a rack bar 112 including tie rods 122 and knuckle arms 124 at both ends thereof.

The steering column 130 includes a steering shaft 106 which has one side connected to the steering wheel 102 and rotating along with the steering wheel 102, and the other side connected to a pinion shaft 108 by means of a universal joint 104. Further, the pinion shaft 108 is connected to a rack bar 112 through a rack and pinion mechanism 110, and both ends of the rack bar 112 are connected to wheels 126 through tie rods 122 and knuckle arms 124, respectively.

An auxiliary power mechanism 140 includes a torque sensor 142 for detecting a torque applied to the steering wheel 102 by a driver to output an electric signal in proportion to the detected torque, an electronic control unit 144 for generating a control signal based on an electric signal received from the torque sensor 142, an electric motor 146 for generating auxiliary power based on the control signal received from the electronic control unit 144, and a reducer 150 having a worm 152 and a worm wheel 156 in order to transfer the auxiliary power generated by the electric motor 146 to the steering shaft 106.

Accordingly, in the electric power steering apparatus, the torque generated by a rotation of the steering wheel 102 is transferred to a rack bar 112 through the rack and pinion mechanism 110, and the auxiliary power generated by the electric motor 146 is transmitted to the rack bar 112 according to the generated torque.

That is, the torque generated by the rotation of the steering wheel 102 and the auxiliary power generated by the electric motor 146 are added up to enable the rack bar 112 to move in an axial direction.

FIG. 2 is a sectional view illustrating a reducer of the conventional electric power steering apparatus. As shown in FIG. 2, the reducer 150 includes a worm shaft 254 on which a worm 152 is formed, worm shaft bearings 257 mounted on both ends of the worm shaft 254 respectively to support the worm shaft 254, a plug bolt 210 disposed between a damping coupler 240 and a worm shaft bearing 257 in order to prevent the worm shaft bearings 257 from being spaced in an axial direction of the worm shaft 254, and a plug nut 220 for fixing the plug bolt 210.

The worm shaft 254 is connected to the electric motor 146 by means of the damping coupler 240, which is rotated by a driving of the electric motor 146.

The worm wheel 156 is disposed on a side of an outer periphery of the worm 152 and is tooth-engaged with the worm 152 formed on the worm shaft 254. The worm wheel 156 is mounted on the steering shaft 106 which transmits a rotation force of the steering wheel 102 operated by the driver, and transfers the rotation force of the worm shaft 254 generated by the driving of the electric motor 146 to the steering shaft 106.

A gear housing 260 has the worm 152, the worm wheel 156 and the like disposed therein, the electric motor 146 mounted on a side thereof to provide a driving force to the worm shaft 254, and a motor cover 230 combined with the electric motor 146 is coupled with the gear housing 260 by means of a bolt 250.

The reducer of the electric power steering apparatus having the above described structure controls a driving of the electric motor by means of the electronic control unit provided to a vehicle according to a driving status of the vehicle. The rotation force of the worm shaft is added to the rotation force of the steering wheel operated by the driver, and is transmitted to the steering shaft, thereby smoothly and stably maintaining the steering status of the driver.

However, in the reducer of the conventional electric power steering apparatus, tolerance at an assembled portion of the worm shaft and the electric motor shaft is accumulated during manufacturing and assembling processes of the reducer, thereby blocking a bearing and increasing a rotation resistance of the worm shaft. Further, as the endurance of the worm and the worm wheel are performed, there are problems in that spacing is generated due to an abrasion, and a rattling noise is caused due to backlash. In addition, the rattling noise caused by an impact transferred through wheels and the steering shaft from the road gives the driver an unpleasant feeling when the driver operates the steering wheel.

### SUMMARY OF THE INVENTION

The present invention has been developed to solve the problems in the conventional art, and an aspect of the present invention is to provide a reducer of an electric power steering apparatus, which is capable of reducing a rattling noise caused by an increase of a backlash due to a friction and an abrasion of a worm and a worm wheel, or by an impact transferred through a wheel and a steering shaft from the road and allowing a pivotal movement of the worm shaft, while decreasing a blockage between the worm shaft and a worm shaft bearing and a rotation resistance to improve the steering feeling of the driver.

In accordance with an aspect of the present invention, a reducer of an electric power steering apparatus is provided. The reducer includes: a worm shaft bearing mounted on one end of a worm shaft connected to and proximal to a motor shaft; a damper which encloses both sides and an outer race of the worm shaft bearing, for providing an elastic force to the worm shaft bearing in axial and radial directions; and a plug bolt which is coupled to a gear housing, for supporting an outer peripheral surface and a side end of the damper in the axial and radial directions.

According to the present invention, the reducer of the electric power steering apparatus can reduce the rattling noise caused by an increase of backlash due to friction and abrasion of a worm and a worm wheel or by an impact transferred through a wheel and a steering shaft from the road and allowing a pivotal movement of a worm shaft, while decreasing a rotation resistance and blockage of a worm shaft and a worm shaft bearing to increase the driver's steering feeling.

### BRIEF DESCRIPTION OF DRAWINGS

The above and other aspects, features, and advantages of the present invention will be more apparent from the following detailed description taken in conjunction with the accompanying drawings, in which:

FIG. 1 is a view illustrating a structure of a conventional electric power steering apparatus;

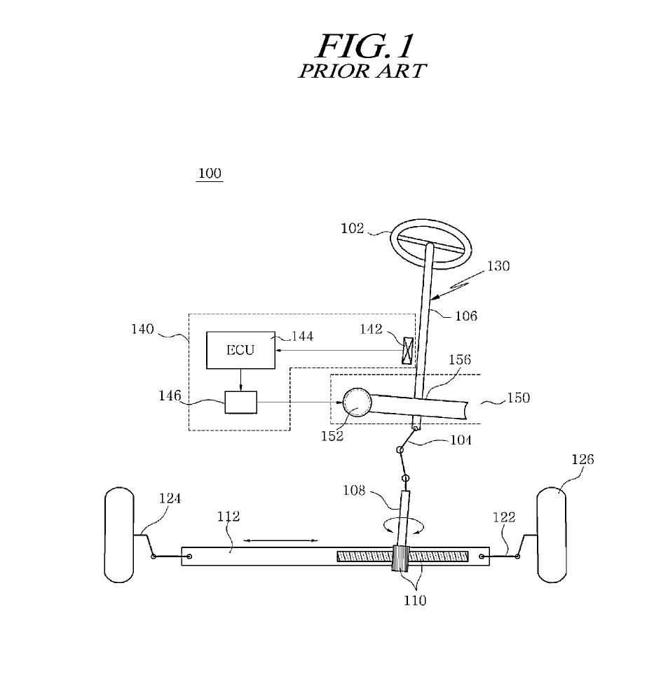

FIG. 2 is a sectional view illustrating a reducer of the conventional electric power steering apparatus;

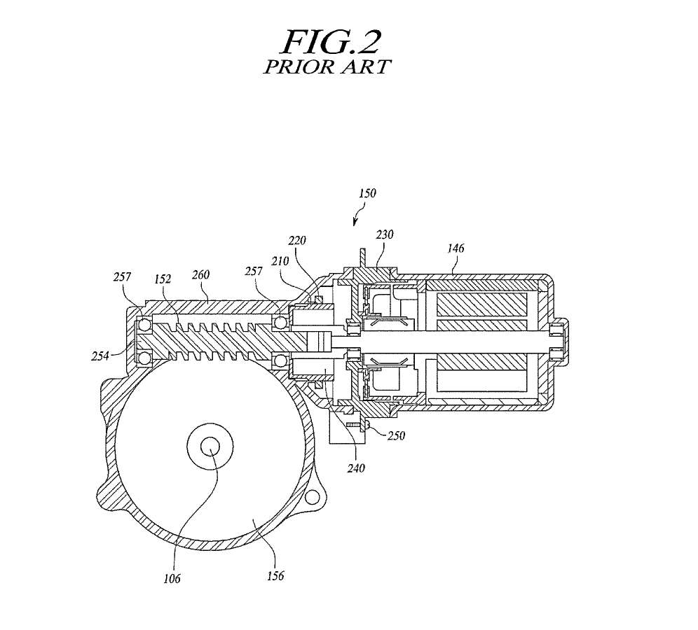

FIG. 3 is a sectional view illustrating a reducer of an electric power steering apparatus according to an embodiment of the present invention; and

FIG. 4 is a sectional view illustrating a reducer of an electric power steering apparatus according to another embodiment of the present invention.

### DETAILED DESCRIPTION OF THE EXEMPLARY EMBODIMENTS

Hereinafter, exemplary embodiments of the present invention will be described with reference to the exemplary drawings. In the description of the elements of the present invention, terms “first”, “second”, “A”, “B”, “(a)”, “(b)” and the like may be used. These terms are merely used to distinguish one structural element from other structural elements, and a property, an order, a sequence and the like of a corresponding structural element are not limited by the term. In the case that it is described that a certain structural element “is connected to”, “is coupled to”, or “is in contact with” another structural element, it should be interpreted that another structural element may “be connected to”, “be coupled to”, or “be in contact with” the structural elements as well as that the certain structural element is directly connected to or is in direct contact with another structural element.

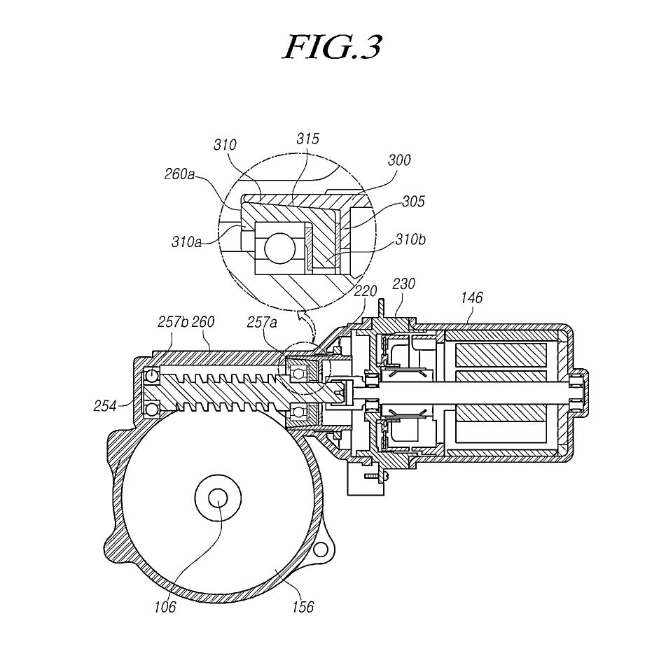

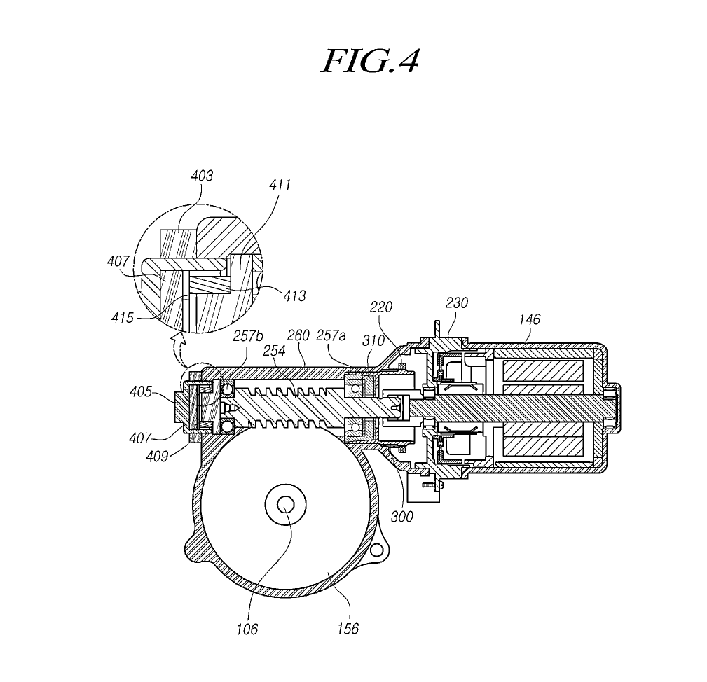

FIG. 3 is a sectional view illustrating a reducer of an electric power steering apparatus according to an embodiment of the present invention, and FIG. 4 is a sectional view illustrating a reducer of an electric power steering apparatus according to another embodiment of the present invention.

As shown in FIG. 3, the reducer of the electric power steering apparatus according to the embodiment of the present invention includes: a worm shaft bearing 257a mounted on one end of the worm shaft 254 connected to a motor shaft; a damper 310 enclosing an outer race and both side ends of the worm shaft bearing 257a to provide an elastic force to the worm shaft bearing 257a in axial and radial directions; and, a plug bolt 300 assembled with a gear housing 260 to support an outer peripheral surface and a side end of the damper 310.

The worm shaft bearings 257a and 257b, which are mounted on one end of the worm shaft 254 connected to the motor shaft and the other end opposite to the one end, have balls interposed between an inner race and the outer race, so as to support a rotation of the worm shaft 254.

In the reducer, the worm shaft 254 and the worm wheel 156 are associated with each other by a driving force of the electric motor 146 to rotate the steering shaft 106, so as to assist a steering force of a driver. The worm shaft bearings 257a and 257b are mounted on both ends of the worm shaft 254 associated with the motor shaft to support the rotation of the worm shaft 254 when the electric motor 146 is driven. The worm wheel 156 and the worm shaft 254 associated with the steering shaft 105 is embedded in the gear housing 260.

The worm shaft bearings 257a and 257b are disposed in the gear housing 260, which support the rotation of the worm shaft 254 at both ends of the worm shaft 254 to reduce a rotation resistance of the worm shaft 254. A portion at which the worm shaft 254 and the motor shaft are connected to each other corresponds to a connection of the shafts by means of a damping coupler or both a boss of the electric motor and the plug bolt 300, at which blockage of the bearing increases due to accumulated tolerance in the manufacturing and assembling processes of the reducer. Thereby, the rotation resistance of the worm shaft 254 increases.

Further, when an external force is transferred through a wheel and the steering shaft 106 from the road to the worm wheel 156, the worm shaft 254 engaged with the worm wheel 156 is twisted at a predetermined angle in an axial direction and has elastic deformation.

Accordingly, the damper 310 and the plug bolt 300 are mounted on the one end of the worm shaft 254 connected to the motor shaft so as to absorb vibrations and noise generated when the worm shaft 254 is twisted at the predetermined angle in the axial direction by the external force transferred through the worm wheel 156 and an operation of the worm shaft 254 and the worm wheel 156 to have the elastic deformation.

The damper 310 encloses both side ends and the outer race of the worm shaft bearing 257a mounted on the one end of the worm shaft 254 connected to the motor shaft to provide an elastic force to the worm shaft bearing 257a in axial and radial directions.

Further, the plug bolt 300 is disposed between the outer side of the damper 310 and the gear housing 260 and fixed to an inner peripheral surface of the gear housing 260 by screw to support an outer peripheral surface and a side end of the damper 310 in axial and radial directions.

Further, a hollow damper 310 through a center portion of which a worm shaft 254 extends includes a body portion enclosing the outer race of the worm shaft bearing 257a, and supporting portions 310a and 310b which radially extends from both ends of the body portion respectively to support the worm shaft bearing 257a in an axial direction. Thus, the hollow damper 310 may provide an elastic force to the worm shaft bearing 257a in the radial and axial directions.

On the other hand, a fixing portion 305 which longitudinally divides an inner space of the hollow plug bolt 300 into two parts is formed on an inner peripheral surface of the hollow plug bolt 300 to be perpendicular to the inner peripheral surface, and a hole is formed at a center portion of the fixing portion 305, through which the worm shaft 254 extends.

Further, the supporting portion 310b of the supporting portions 310a and 310b of the damper 310 is supported by the fixing portion 305 of the plug bolt 300, and the fixing portion 305 urges the damper 310 in the axial direction when the plug bolt 300 is assembled with the gear housing 260.

Here, the damper 310 has a body portion enclosing the outer race of the worm shaft bearing 257a and the supporting portions 310a and 310b formed of an elastic material on both sides of the body portion, and supporting plates made of a metal material are attached to both sides of the supporting portion 310b formed at a side of the body portion supported by the fixing portion 305 of the plug bolt 300, respectively.

Further, one end of the supporting plates is spaced at a predetermined distance from the inner race of the worm shaft bearing 257a in the axial direction, and the other end of the supporting plates protrudes in the axial direction to be in close contact with the outer race of the worm shaft bearing 257a.

The damper 310 may be formed in such a manner that an elastic material is injection-molded between the supporting plates so that the body portion and the supporting portions 310a and 310b are integrally formed together with the supporting plates. Alternatively, the damper 310 may be formed by adhering the supporting plates made of the metal material on both sides of the supporting portion 310b using a vulcanized adhesive.

That is, the body portion and the supporting portions 310a and 310b of the damper 310 are required to be formed of a material having abrasion resistance, low friction, a desired flexural strength, rigidity, and a low heat-sink ability. Thus, they are formed of an engineering plastic based material such as polyacetal (POM), polyamide (PA), poly carbonate (PC), polyimide (PI), polybutylene terephthalate (PBT), and the like, or a material such as natural rubber (NR), nitride butadiene rubber (NBR), chloroprene rubber (CR), ethylene propylene terpolymer (EPDM), fluoro elastomer (FRM), styrene butadine rubber (SBR), chlorosulphonated polyethylene (CSM), silicon, urethane, and the like in order to have weather proof and resilience.

Meanwhile, the plug bolt 300 has a tapered portion 315 of which a diameter gradually increases from the fixing portion 305 to one end thereof enclosing the body portion of the damper 310, and the body portion of the damper 310 is elastically compressed by the tapered portion 315 when the plug bolt 300 is assembled with the gear housing 260.

Accordingly, when the plug bolt 300 is coupled to the gear housing 260, it elastically deforms the damper 310 while applying a preload to the worm shaft bearing 257a by using the elastic force of the damper 310, thereby assembling the plug bolt 300 with the gear housing 260. Simultaneously, the worm shaft 254 is elastically deformed in the axial direction or twisted at a predetermined angle to the axial direction, and is capable of performing a pivotal movement, resulting in absorption of vibrations and noise generated at a connection portion of the worm shaft 254 and the motor shaft.

On the other hand, in the embodiment as shown in FIG. 4, a guide 411, a damping member 413, and an adjustment plug 405 are mounted on the other end of the worm shaft 254 connected to and distal from the motor shaft so as to absorb vibrations and noise generated when the worm shaft 254 is twisted at the predetermined angle in the axial direction by the external force transferred through the worm wheel 156 and an operation of the worm shaft 254 and the worm wheel 156 to have the elastic deformation.

The guide 411 is disposed on an outer side of the worm shaft bearing 257b mounted on the other end of the worm shaft to support the outer race of the worm shaft bearing 257b in an axial direction, and generally includes a large diameter portion for supporting the outer race of the worm shaft bearing 257b and a small diameter portion which has a diameter reduced from the large diameter portion.

The damping member 413 is fitted on an outer periphery of the small diameter portion of the guide 411 so as to provide an elastic force to the guide 411 in an axial direction. The guide 411 is elastically supported in a direction of the worm shaft bearing 257a by an elastic force of the damping member 413 generated by a pressing force of an adjustment plug 405 which is press-fitted or screwed in the gear housing 260, thereby absorbing a vibration and a noise transferred through the worm shaft 254.

The adjustment plug 405, which supports the damping member 413 in the axial direction as described above, extends through a side of the gear housing 260 and is assembled with the gear housing 260. In other words, the adjustment plug 405 may be press-fitted to the gear housing 260, or has thread formed on an outer peripheral surface thereof and may be screwed in the gear housing 260 which has screw thread formed therein and engaged with the thread, so as to adjust an elastic supporting force of the damping member 413, i.e., a compressed force of the damping member 413.

Accordingly, depending on the coupling amount of the adjustment plug 405 and the gear housing 260, the compressed amount, i.e., an elastic supporting force, of the damping member 413 may be adjusted as the adjustment plug 405 is moved in the axial direction of the worm shaft 254. However, the coupling of the adjustment plug 405 to the gear housing 260 is not limited to the above mentioned case, and according to the cases, as shown in FIG. 4, instead of that the screw thread is not formed in the gear housing 260, the adjustment plug 405 may be coupled to the gear housing 260 by using a lock nut 403 having a screw thread on an inner peripheral surface thereof.

On the other hand, a bush 415 may be interposed between the damping member 413 and the adjustment plug 405 to support the elastic deformation of the damping member 413, and a spacer 407 which is formed of an elastic material having modulus elasticity larger than that of the damping member 413 may be interposed between the bush 415 and the adjustment plug 405.

Accordingly, the damping member 413 and the spacer 407 having the different modulus of elasticity are coupled to each other in the axial direction, so as to absorb the rattle noise generated by an external force transferred in the form of various forces.

That is, in the case that the small load is transferred, the damping member 413 supports the load by its elastic force, while in the case that the large load is momentarily transferred, the damping member 413 becomes the center of absorbing the load and simultaneously supports the large load along with the spacer 407 to absorb the vibration and the noise, thereby preventing the rattling noise of the reducer.

As described above, since the damping member 413, the guide 411 and the like are coupled to the other end of the worm shaft 254 and the adjustment plug 405 coupled to the gear housing 260 adjusts the elastic force of the damping member 413, it is possible to absorb the external force transferred through the steering shaft and the worm wheel 156 from the road and the vibration and the noise generated when the worm shaft and the worm wheel 156, thereby reducing the rattling noise generated in the reducer.

According to the embodiments of the present invention having such a shape and a structure, the reducer of the electric power steering apparatus can reduce the rattling noise caused by an increase of the backlash due to the friction and abrasion of the worm and the worm wheel or by the impact transferred through the wheel and the steering shaft from the road and allowing the pivotal movement of the worm shaft, while decreasing the rotation resistance and blockage of the worm shaft and the worm shaft bearing to increase steering feel of the driver.

Even if it was described above that all of the components of an embodiment of the present invention are coupled as a single unit or coupled to be operated as a single unit, the present invention is not necessarily limited to such an embodiment. Rather, within some embodiments of the present disclosure, the respective components are selectively and operatively combined in any number of ways. Those skilled in the art will appreciate that various modifications, additions and substitutions are possible, without departing from the essential characteristics of the disclosure. Therefore, the exemplary embodiments of the present invention disclosed herein are intended to illustrate the scope of the technical idea of the present invention, and the scope of the present invention is not limited by the exemplary embodiments. The scope of the present invention shall be construed on the basis of the accompanying claims in such a manner that all of the technical ideas included within the scope equivalent to the claims belong to the present invention.

### DESCRIPTION OF REFERENCE NUMERALS

| | |
|---|---|
| 254: worm shaft | |
| 257a, 257b: worm shaft bearing | |
| 300: plug bolt | 305: fixing portion |
| 310: damper | |
| 310a, 310b: supporting portion | |
| 315: tapered portion | 403: lock nut |
| 405: adjustment plug | 407: spacer |
| 411: guide | 413: damping member |
| 415: bush | |

What is claimed is:

1. A reducer of an electric power steering apparatus, the reducer comprising:
a worm shaft bearing mounted on one end of a worm shaft connected to and proximal to a motor shaft;
a damper which encloses both sides and an outer race of the worm shaft bearing, for providing an elastic force to the worm shaft bearing in axial and radial directions; and
a plug bolt which is coupled to a gear housing, for supporting an outer peripheral surface and a side end of the damper in the axial and radial directions.

2. The reducer as claimed in claim 1, wherein the damper includes a body portion enclosing an outer race of the worm shaft bearing, and supporting portions which radially extend from both ends of the body portion to axially support the worm shaft bearing.

3. The reducer as claimed in claim 2, wherein a fixing portion is formed on an inner peripheral surface of the hollow plug bolt to divide an inner space of the hollow plug bolt into two parts in the axial direction, and one of the supporting portions is supported by the fixing portion.

4. The reducer as claimed in claim 3, wherein the body portion and the supporting portions of the damper are formed of an elastic material, and supporting plates made of a metal material are attached to both sides of one of the supporting portions.

5. The reducer as claimed in claim 4, wherein the supporting plate has one end spaced at a desired distance from an inner race of the worm shaft bearing in an axial direction, and the other end protruding in the axial direction and being in close contact with the outer race of the worm shaft bearing.

6. The reducer as claimed in claim 3, wherein the plug bolt has a tapered portion of which a diameter gradually increases from the fixing portion to one end enclosing the body portion of the damper, and is coupled to the gear housing while elastically compressing the body portion.

7. The reducer as claimed in claim 4, wherein the body portion and the supporting portions of the damper are integrally formed by injection-molding an elastic material between the supporting plates.
